(19) United States
(12) Patent Application Publication
(10) Pub. No.: US 2024/0416492 A1
(43) Pub. Date: Dec. 19, 2024

(54) TORQUE ROD PRESS TOOLS, SYSTEMS, AND METHODS

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford (CA)

(21) Appl. No.: 18/819,920

(22) Filed: Aug. 29, 2024

Related U.S. Application Data
(63) Continuation of application No. 17/347,301, filed on Jun. 14, 2021.
(60) Provisional application No. 63/039,286, filed on Jun. 15, 2020.

(51) Int. Cl. B25B 27/00; B25B 27/28

(52) U.S. Cl. CPC B25B 27/0035; B25B 27/28

(57) ABSTRACT

A press tool for disconnecting a torque rod assembly from a structural support comprising an anchor plate, a brace plate, a drive rod supported by the brace plate, and a plurality of spacing members operatively connected to the anchor plate and the brace plate such that the press tool defines a tool opening. At least a portion of the torque rod end and the structural support are passed through the tool opening such that the anchor plate engages at least a portion of the structural member. The drive rod is axially rotated relative to the brace plate such that the drive rod engages at least a portion of the torque rod assembly and displaces the torque rod assembly relative to the structural support.

### RELATED APPLICATIONS

This application (Attorney's Ref. No P220568) is a continuation application of U.S. patent application Ser. No. 17/347,301 filed Jun. 14, 2021, currently pending.

U.S. patent application Ser. No. 17/347,301 claims benefit of U.S. Provisional Application Ser. No. 63/039,286 filed Jun. 15, 2020, now expired. The contents of which are incorporated herein by reference.

### TECHNICAL FIELD

The present invention relates to press tools, systems, and methods and, more specifically, to press tools, systems, and methods that are adapted to remove a torque rod end from a structural support of a vehicle.

### BACKGROUND

Torque rods are often used as part of the suspension system of modern vehicles such as trucks. The disassembly of a torque rod for repair and/or replacement typically requires that an end of the torque rod be detached from a structural support of the vehicle. Access to the torque rod end and the structural support may be limited, so removal of the torque rod end from the structural support using conventional tools can be difficult.

The need thus exists for improved tools, systems, and methods for facilitating the removal of a torque rod end from the flange of a vehicle, and that application of the present invention will be described herein.

### SUMMARY

The present invention may be embodied as a press tool for disconnecting a torque rod assembly from a structural support comprising an anchor plate, a brace plate, a drive rod supported by the brace plate, and a plurality of spacing members operatively connected to the anchor plate and the brace plate such that the press tool defines a tool opening. At least a portion of the torque rod end and the structural support are passed through the tool opening such that the anchor plate engages at least a portion of the structural support. The drive rod is axially rotated relative to the brace plate such that the drive rod engages at least a portion of the torque rod assembly and displaces the torque rod assembly relative to the structural support.

The present invention may also be embodied as a method of disconnecting a torque rod assembly from a structural support comprising the following steps. An anchor plate is provided. A brace plate is provided. A drive rod is supported on the brace plate. A plurality of spacing members is operatively connected to the anchor plate and the brace plate such that the press tool defines a tool opening. At least a portion of the torque rod end and the structural support is passed through the tool opening such that the anchor plate engages at least a portion of the structural support. The drive rod is axially rotated relative to the brace plate such that the drive rod engages at least a portion of the torque rod assembly and displaces the torque rod assembly relative to the structural support.

The present invention may also be embodied as a press tool for disconnecting a torque rod assembly from a structural support comprising an anchor plate, a brace plate, a securing plate, a drive rod supported by the brace plate, and a plurality of spacing members operatively connected to the anchor plate and the brace plate such that the press tool defines a tool opening. A plurality of securing members engaged with the plurality of securing members such that the securing plate is operatively connected to the brace plate. At least a portion of the torque rod end and the structural support are passed through the tool opening such that the anchor plate engages at least a portion of the structural support. The drive rod is axially rotated relative to the brace plate such that the drive rod engages at least a portion of the torque rod assembly and displaces the torque rod assembly relative to the structural support.

### BRIEF DESCRIPTION OF THE DRAWINGS

FIG. 1 is a perspective view of a first example torque rod press tool constructed in accordance with, and embodying, the principles of the present invention;

FIG. 2 is a perspective, exploded view of the first example torque rod press tool;

FIG. 3 is a side elevation view of an example spacing member of the first example press tool;

FIG. 4 is a first end elevation view of an example brace plate of the first example press tool;

FIG. 5 is a second end elevation view of the example brace plate of the first example press tool;

FIG. 6 is a side elevation view of an example drive rod of the first example press tool;

FIG. 7 is an end elevation view of an example anchor plate of the first example press tool;

FIG. 8 is a bottom plan view of the example brace plate of the first example press tool;

FIG. 9 is a top plan view of the first example press tool;

FIG. 10 is a section view taken along lines 10-10 in FIG. 9;

FIG. 11 is a detail view of FIG. 10;

FIG. 12 is a perspective view of a portion of an example torque rod assembly an example structural support to which the torque rod assembly may be attached but with a torque rod pin assembly of the torque rod assembly removed;

FIG. 13 is a perspective view of the example torque rod end with the torque rod pin assembly removed;

FIG. 14 is a perspective view of the example torque rod end with the torque rod pin assembly and bushing removed;

FIG. 15 is a perspective view of a portion of the example torque rod assembly attached to the example structural support;

FIG. 16 is a side elevation view of a portion of the example torque rod assembly attached to the example structural support;

FIG. 17 is a side elevation view of a first step of a method of detaching the example torque rod assembly from the example structural support using the first example torque rod press tool;

FIG. 18 is a side elevation view of a second step of the method of detaching the example torque rod assembly from the example structural support using the first example torque rod press tool;

FIG. 19 is a side elevation view of a third step of the method of detaching the example torque rod assembly from the example structural support using the first example torque rod press tool;

FIG. 20 is a side elevation view of an example bushing plate that may be used to facilitate removal of a bushing from a torque rod end;

FIG. 21 is a side elevation view of a first step of a method of removing of a bushing from a torque rod end using the first example torque rod press tool and the example bushing plate;

FIG. 22 is a side elevation view of a second step of a method of removing of a bushing from a torque rod end using the first example torque rod press tool and the example bushing plate;

FIG. 23 is a perspective, exploded view of a second example torque rod press tool constructed in accordance with, and embodying, the principles of the present invention;

FIG. 24 is a perspective of the second example torque press tool;

FIG. 25 is a side elevation view of the second example torque press tool; and

FIG. 26 is a section view taken along lines 26-26 of FIG. 25.

### DETAILED DESCRIPTION

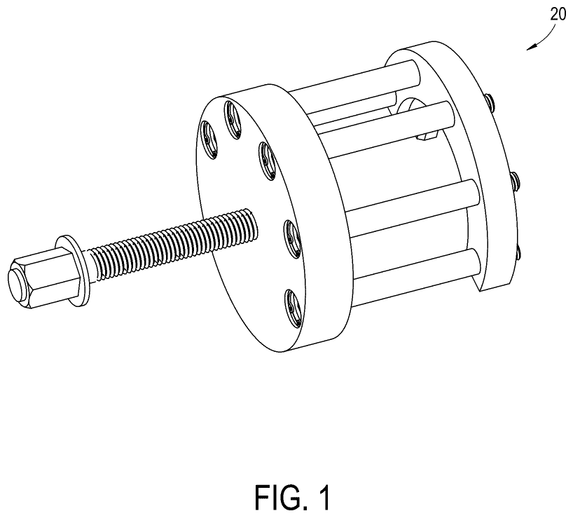

Referring initially to FIG. 1 of the drawing, depicted therein is a first example torque rod press tool 20 constructed in accordance with, and embodying, the principles of the present invention. FIG. 1 further illustrates that the first example torque rod press tool 20 may be used to disassemble an example torque rod assembly 22 from an example structural support 24. The structural support 24 and torque rod assembly 22 are or may be conventional and will be described herein only to that extent helpful to a complete understanding of the present invention.

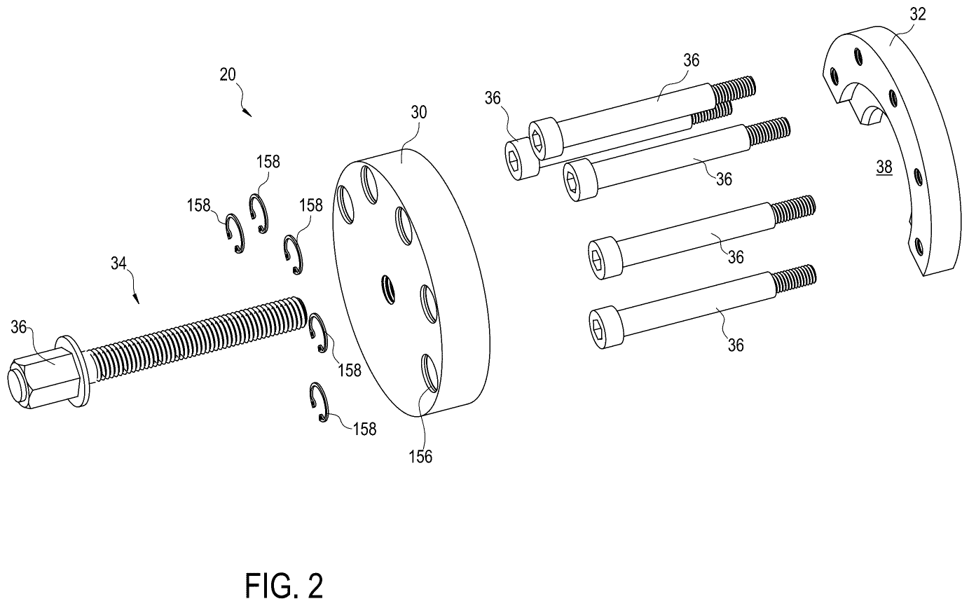

As illustrated in FIG. 2, the example torque rod press tool 20 comprises an anchor plate 30, a brace plate 32, a drive rod 34, and a plurality of spacing members 36. In use, the brace plate 32 supports the drive rod 34. Depending on the size and configuration of the torque rod assembly 22 and the structural support 24, and the plurality of first spacing members 36 is arranged to fix a distance between the anchor plate 30 and the brace plate 32. When the distance between the anchor plate 30 and brace plate 32 is fixed, the first example press tool 20 is in a desired configuration and defines a tool opening 38.

With the first example press tool 20 in the desired configuration, the example press tool 20 is arranged such that at least a portion of the torque rod assembly 22 and at least a portion of the structural support 24 enters the tool opening 38 such that the brace plate 32 engages the structural support 24. The drive rod 34 is then axially rotated to cause the drive rod 34 to engage and displace at least a portion of the torque rod assembly 22 relative to the structural support 24 to disassemble the torque rod assembly 22 from the structural support 24.

With the foregoing general understanding of the construction and operation of the present invention in mind, the first example torque rod press tool 20, the example torque rod assembly 22, and the example structural support 24 will now be described in further detail.

Referring to FIGS. 4 and 5, the example anchor plate 30 defines an anchor perimeter edge surface 120, an anchor inner surface 122, an anchor outer surface 126, a drive bore 146, and a set of anchor bores 126. The example drive bore 146 is threaded. The example anchor bores 126 comprises an anchor bore outer portion 150 and an anchor bore inner portion 152, and an anchor bore engaging surface 154 is defined by the example anchor plate 30 within each of the anchor bores 126. The example anchor plate 30 defines a clip recess 156 within the anchor bore outer portion 150. The example clip recess 156 is adapted to receive an anchor retaining clip 158, as depicted in FIG. 2. The shape of the example brace perimeter edge surface 120 defines an anchor plate configuration as shown in FIGS. 4 and 5. FIGS. 4 and 5 also illustrate that the example anchor bores 126 are arranged in an anchor bore pattern. The example anchor bore pattern defined by the anchor plate 30 substantially matches the example brace bore pattern defined by the brace plate 32.

Referring now to FIGS. 7-8, the example brace plate 32 defines a brace plate outer edge 140, a brace plate front side inner surface 142, a brace plate back side inner surface 144, a base plate inner edge 146, and a set of brace bores 148. The example brace plate front side inner surface 142 defines a main portion 130, an offset portion 132, and a transition portion 134. The example brace bores 148 are threaded.

The shape of the example base plate inner edge 146 defines a brace plate configuration as depicted in FIG. 7. FIG. 7 also shows that the example brace bores 148 are arranged in a brace bore pattern. The exact brace plate configuration and the brace bore pattern are not critical so long as the press tool 20 of the present invention defines the tool opening 38 such that the press tool 20 may be arranged relative to the torque rod assembly 22 and structural support 24 as will be described in further detail below. The example brace plate configuration is generally circular but extends in a brace plate arc of approximately 190-210 degrees such that the base plate inner edge 146 is open and defines a notch 146a defining at least a portion of the tool opening 38. The brace bore pattern is centered on an axis of the brace plate configuration and extends in an arc of approximately 170-190 degrees with the brace bores 148 arranged at substantially evenly spaced intervals around the bore pattern arc.

As perhaps best shown in FIG. 8, a thickness of the brace plate 32 at the main portion 130 is larger than a thickness of the brace plate 32 at the offset portion 132. The thicker main portion 130 allows secure engagement of the spacing members 36 with the anchor plate 30, and the thinner offset portion 132 facilitate engagement of the brace plate 32 with the structural support 24 and/or or the torque rod end 52 as will be described in further detail below.

The exact brace plate configuration and the brace bore pattern are not critical so long as the press tool 20 of the present invention defines the tool opening 38 such that the press tool 20 may be arranged relative to the torque rod assembly 22 and structural support 24 as will be described in further detail below. The example brace plate configuration is generally round or semi-circular to facilitate manufacturing of the brace plate 32.

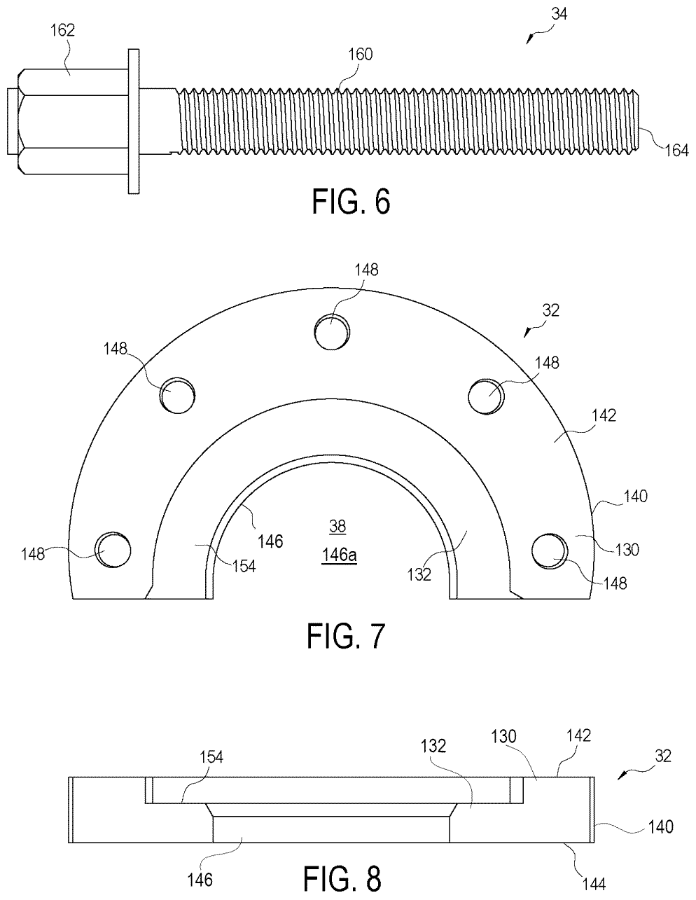

The example drive rod 34 defines a drive rod shaft 160, a drive rod head 162, and a drive rod end surface 164, as depicted in FIG. 6. At least a portion of the example drive rod shaft 160 is threaded to engage the threaded drive bore 146. In the example drive rod 34, the drive rod head 162 is arranged on an opposite end of the drive rod shaft 160 from the drive rod end surface 164. The drive rod head 162 is configured to facilitate axial rotation of the drive rod 34, and the example drive rod head 162 takes the form of a standard hex drive.

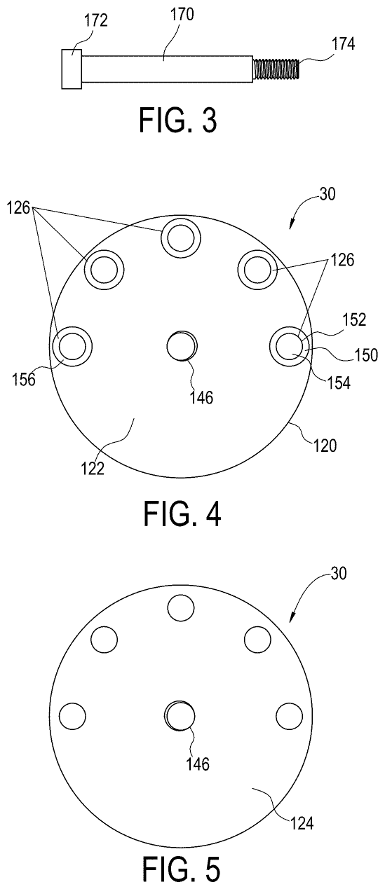

Each of the first spacing members 36 defines a spacing member shaft 170, a spacing member head 172, and a spacing member anchor portion 174, as shown in FIG. 3. In the example first spacing member 36, the spacing member head 172 is arranged on an opposite end of the spacing member shaft 170 from the spacing member anchor portion 174. The head portions 172 of the example first spacing members 36 are sized and dimensioned to be received at least partly within brace bore outer portion 150 and to engage the brace bore engaging surface to prevent the first spacing members 36 from passing entirely through the brace bores 148. The anchor portions 174 of the example first spacing members 36 are threaded to engage the threaded anchor bores 128. A distance between the head portions 172 and the anchor portions 174 is determined by a length of the spacing member shaft 170. As will be described in further detail below, the length of the spacing member shaft 170 determines a distance between the anchor plate 30 and the brace plate 32 and thus an effective length of the press tool 20.

To assemble the example press tool 20, the anchor plate 30 and brace plate 32 are arranged such that the anchor bores 126 are aligned with the brace bores 148. The first spacing members 36 are then inserted through the brace bores 148 and axially rotated such that the spacing member anchor portions 174 threadingly engage the anchor bores 128. The brace plate 32 is then displaced relative to the anchor plate 30 such that the spacing member heads 172 engage the anchor bore engaging surfaces 154. At that point, the example press tool 20 is in its desired configuration. The brace plate 32 is configured to be easily removable and/or interchangeable if the example press tool 20 needs to be serviced, without taking the entire press tool 20 apart.

The anchor retaining clips 158 may be inserted into the anchor bore clip recesses 156 to maintain the example press tool 20 in the desired configuration. The drive rod 34 is then inserted into the drive bore 146 and axially rotated in a first direction relative to the brace plate 32 such that the drive rod 34 threadingly engages brace plate 32. Further axial rotation of the drive rod 34 in the first direction relative to the brace plate 32 displaces the drive rod 34 relative to the brace plate 32 such that the drive rod end surface 164 is displaced towards the anchor plate 30 such that drive rod end surface 164 is arranged between the anchor inner surface 124 and the brace inner surface 142.

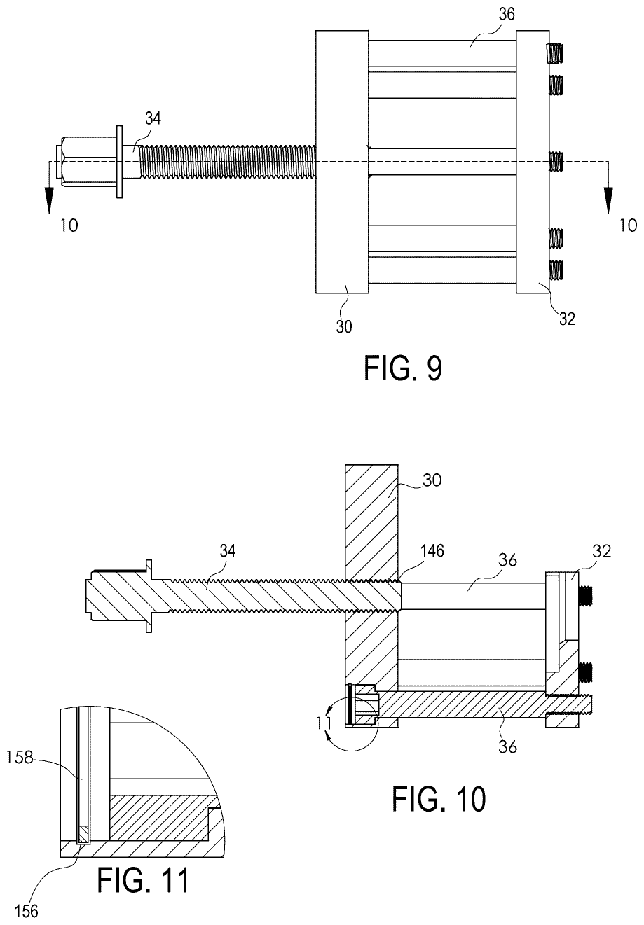

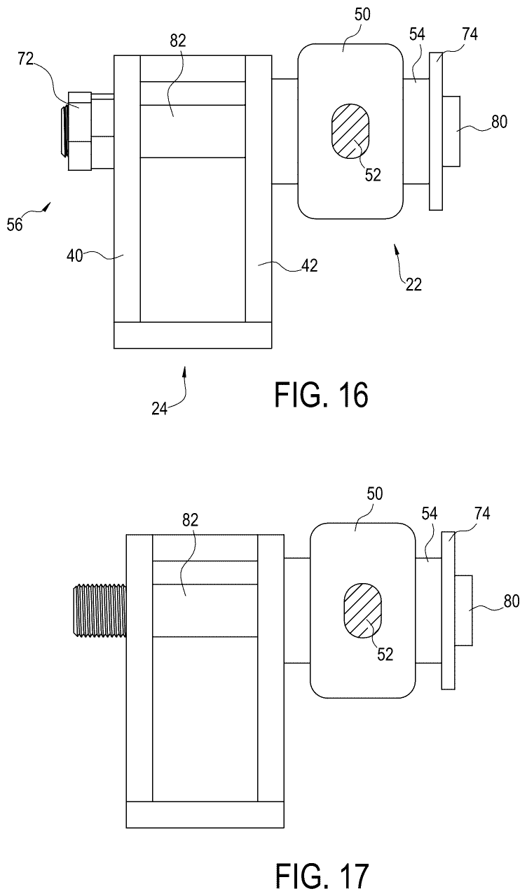

Referring to FIGS. 9-11, when the example press tool 20 is assembled, the tool opening 38 is defined by the anchor plate 30, the brace plate 32, two of the spacing members 36. The spacing members 36, the example anchor plate configuration, the example brace plate configuration, the example anchor bore pattern, and the example brace bore pattern are configured such that the tool opening 38 allows the example press tool 20 to be placed over the structural support 24 and the torque rod end 52 such that the example press tool 20 is in a pre-operational position relative to the torque rod assembly 22 and the structural support 24 as shown in FIG. 16.

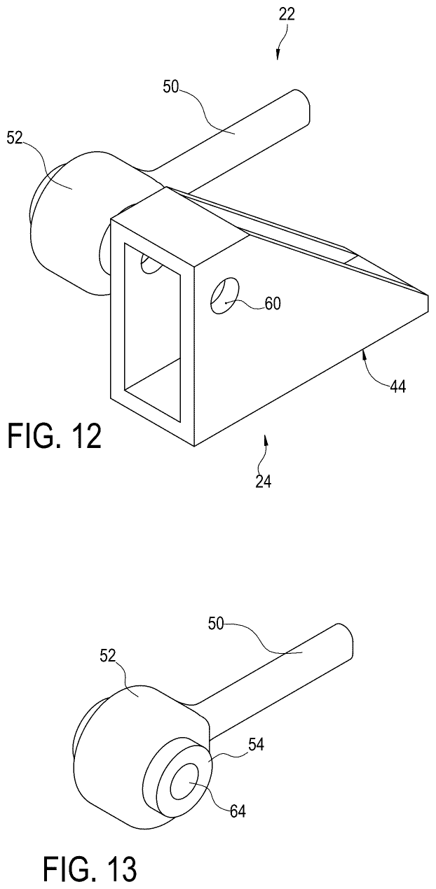

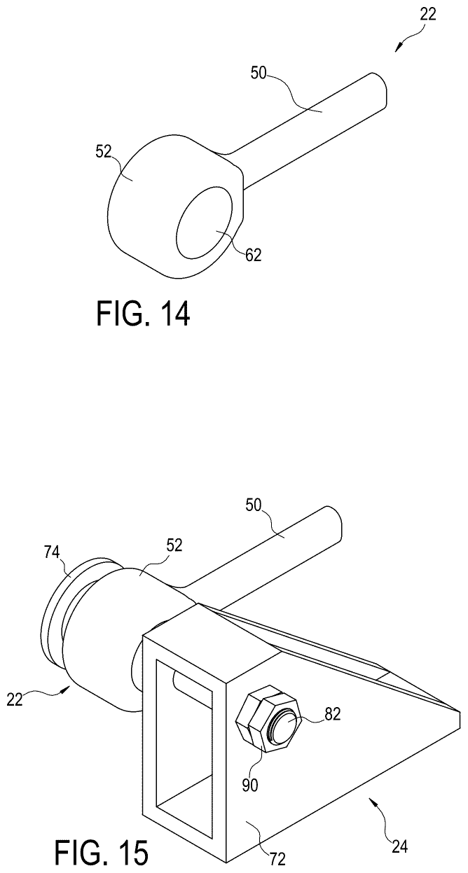

Referring to FIGS. 16 and 17, the example structural support 24 comprises a first flange 40, a second flange 42, and a structural member 44. Referring to FIGS. 12-14, the example torque rod assembly 22 comprises a torque rod 50 comprising a torque rod end 52, a bushing 54, and a torque rod pin assembly 56. The structural member 44 defines a structural bore 70, the torque rod end 52 defines a torque rod end bore 62, and the bushing 54 defines a bushing bore 64. The example torque rod pin assembly 56 comprises a torque rod pin 70, at least one torque rod pin nut 72, and a torque rod plate 74. The torque rod pin 70 defines a pin head 80 and a pin shaft 82. At least a portion of the pin shaft 82 is threaded, and each pin nut 72 defines a nut opening 90 that is threaded to engage the threaded portion of the pin shaft 82, as shown in FIG. 15.

Referring to FIGS. 16-17, support 24 by arranging the bushing 54 within the torque rod end bore 62, aligning the bushing bore 64 with the structure bore 60, and arranging at least a portion of the torque rod pin 70 through the bushing bore 64 and the structure bore 60 such that the pin plate 76 is arranged between the pin head 80 and the torque rod end 52 and a portion of the pin shaft 82 extends from the structure bore 60. At least one torque rod pin nut 72 is threaded onto a portion of the pin shaft 82 extending from the structure bore 60 such that the structural support 24 is clamped between torque rod pin nuts 72 and the torque rod plate 74. So assembled, the example pin assembly 58 limits relative movement between the torque rod end 52 and the structural member 44.

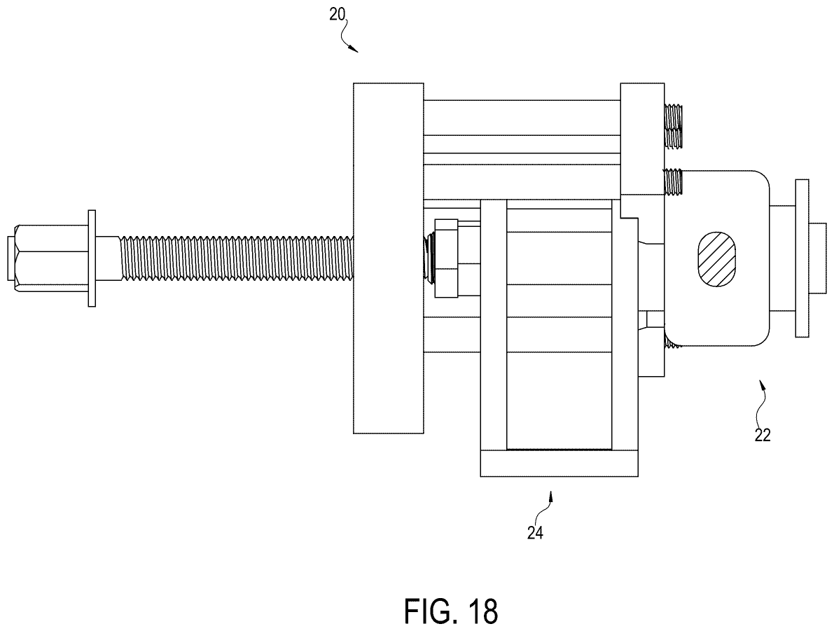

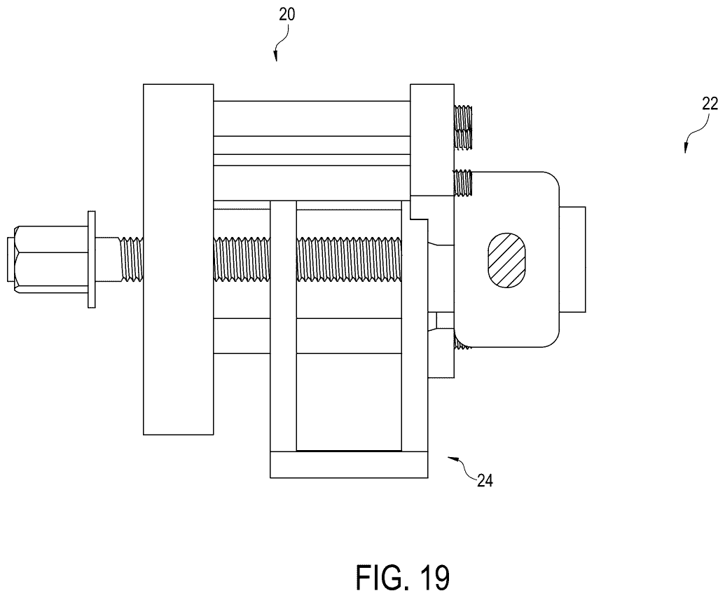

In the pre-operational configuration, the anchor plate 30 is arranged to engage the structural support 24, the drive rod 34 is substantially axially aligned with the torque rod pin 70, and the drive rod end surface 164 faces but is spaced from the torque rod pin 70. Axial rotation of the drive rod 34 in the first direction causes the drive rod end surface 164 to engage the torque rod pin 70. Because the anchor plate 30 is in contact with the structural support 24, a distance between the anchor plate 30 and the brace plate 32 is fixed by the first spacing members 36, and the drive rod 34 is supported by the drive bore 146 in the brace plate 32, continued axial rotation of the drive rod 34 in the first direction displaces the torque rod pin assembly 56, bushing 54, and torque rod end 52 relative to the structural support 24. Axial rotation of the drive rod 34 in the first direction eventually forces the torque rod pin 70 entirely out of the structure bore 60 as shown in FIGS. 18 and 19. The example brace plate 32 defines a clip recess 156 within the brace bore outer portion 150. The example clip recess 156 is adapted to receive an anchor retaining clip 158. At this point, the torque rod assembly 22 is disconnected from the structural support 24 and may be replaced or repaired.

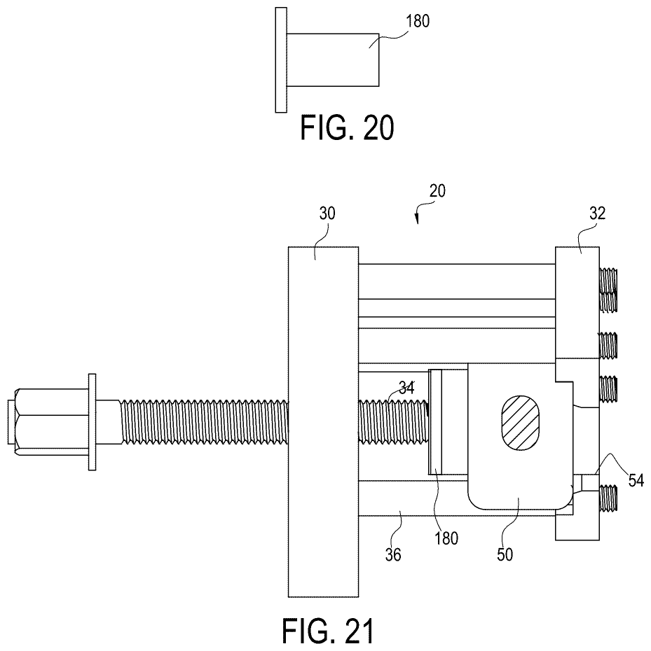

The example press tool 20 may also be used to facilitate removal of the bushing 54 from the torque rod end bore 64 to facilitate repair of the torque rod assembly 22. As shown in FIGS. 20-21, a bushing plate 180 is arranged on the drive rod 34, and the example press tool 20 is placed over the torque rod end 52 such that the example press tool 20 is in a pre-operational position relative to the bushing 54 and the torque rod end 52 as shown in FIG. 21.

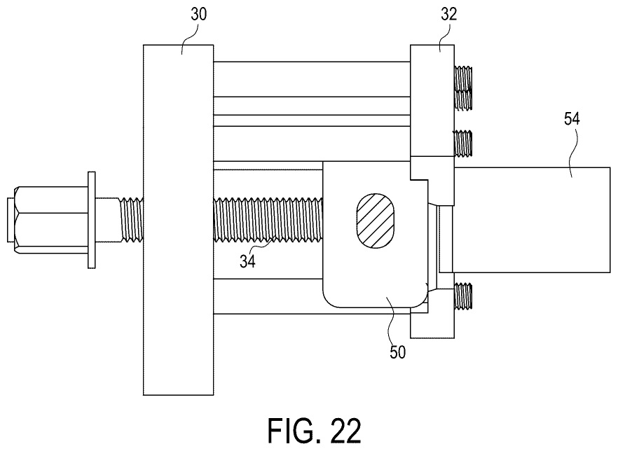

In the pre-operational configuration, the anchor plate 30 is arranged to engage the torque rod end 52, the drive rod 34 is substantially axially aligned with the bushing bore 64 defined by the bushing 54, and bushing plate 180 on the drive rod end surface 164 faces but is spaced from the bushing 54. Axial rotation of the drive rod 34 in the first direction causes the bushing plate 180 to engage the bushing 54. Because the anchor plate 30 is in contact with the torque rod end 52, a distance between the anchor plate 30 and the brace plate 32 is fixed by the first spacing members 36, and the drive rod 34 is supported by the drive bore 146 in the brace plate 32, continued axial rotation of the drive rod 34 in the first direction displaces the bushing 54 relative to the torque rod end 52. Axial rotation of the drive rod 34 in the first direction eventually forces the bushing 54 entirely out of the torque rod end bore 62 as shown in FIG. 22. At this point, the bushing 54 is removed from the torque rod end 52 and may be replaced.

The drive rod 34 may be axially rotated by rotating the drive rod head 162 using a manual tool such as a wrench (not shown) sized and dimensioned to engage the drive rod head 162 or a power tool such as an impact driver (not shown) and a socket drive (not shown) configured to engage the drive rod head 162.

The example press tool 20 may also be used with additional brace plates, drive rods, and sets of spacing members (not shown). In particular, different brace plates with different configurations of tool opening 38 and brace inner surfaces 154 may be provided for different torque rod assemblies and structural supports. For example, a particular make and model of vehicle may employ a brace plate 32 having a given configuration, drive rod 34, and a set of spacing members 36 defining a given configuration and effective length based on the size, dimensions, and configuration of the torque rod assembly 22 and structural support 24 of that particular make and model of vehicle. The additional spacing members, if used, are or may be the same as the first example spacing members 36 except that an effective length of the spacing members in each additional set is different from an effective length of the first example spacing members 36. The use of one or more additional brace plates, drive rods, and sets of spacing members thus facilitates the reconfiguration of the example press tool 20 between two or more desired configurations selected based on the characteristics of the torque rod assembly 22 and structural support 24 on which the example press tool 20 will be used. The example press tool 20 can thus easily be reconfigured to accommodate different configurations of the torque rod assembly 22 and structural support 24 as determined by different environments in which the torque rod assembly 22 and structural support 24 are used.

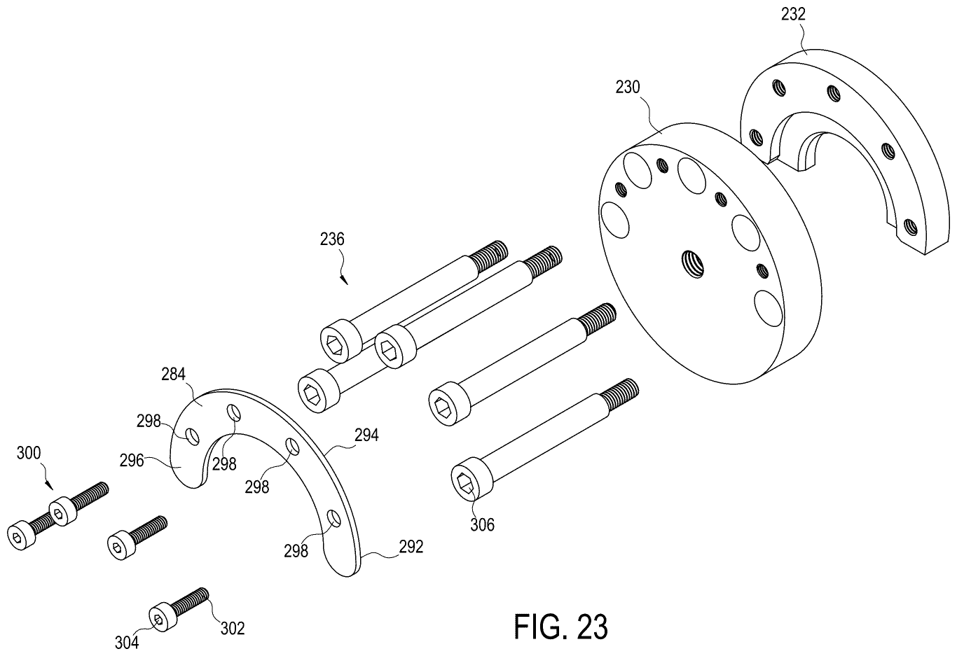

Referring now to FIGS. 23-26 of the drawings, depicted therein is a second example press tool 220 constructed in accordance with, and embodying, the principles of the present invention. The second example press tool 220 may also be used to disassemble the example torque rod assembly 22 and the example structural support 24, described above.

The second example press tool 220 comprises an anchor plate 230, a brace plate 232, a plurality of spacing members 226, a securing plate 284, and a plurality of securing members 286. As described above, the size and configuration of the torque rod assembly 222 and the structural assembly 224, and the plurality of spacing members 226 is arranged to fix a distance between the anchor plate 230 and the brace plate 232.

The example anchor plate 230 and the brace plate 232 are or may be the same as the example anchor plate 230 and brace plate 232 described above and will not be described herein again in detail.

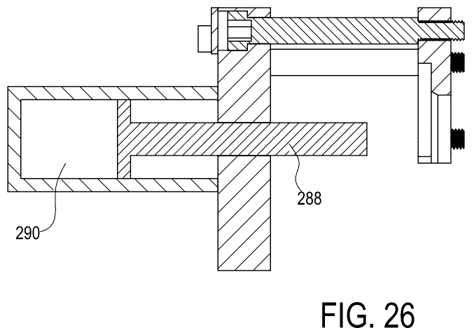

The anchor plate 230 defines a drive bore 346. In one embodiment, the drive bore may be threaded and configured to receive a drive rod 234 (not shown). The drive rod 234 may be the same or similar to the example drive rod 34, described above. In one embodiment, the drive rod 234 of the second example press tool 220 may use axial rotation to displace the torque rod assembly 222 from the structural assembly 224. In another embodiment, as shown in FIGS. 25-26, the second example press tool 220 may utilize a piston 288 to displace the drive rod 234 such that the torque rod assembly disengages from the structural assembly 224. The piston 288 is connected to the piston cylinder 290. When the second example press tool 220 is operational, the piston 288 displaces the drive rod 234, which displaces the torque rod assembly 256, bushing 254, and a torque rod end 252 relative to the structural support 224.

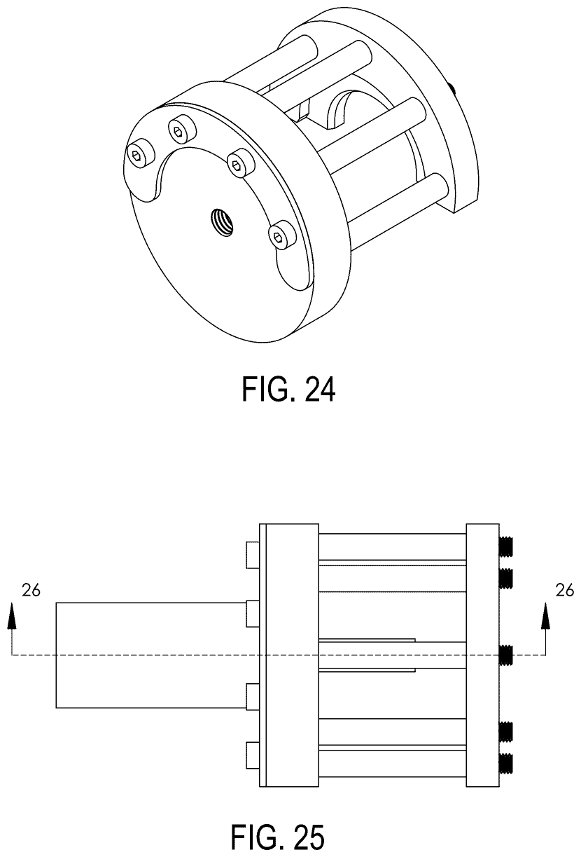

Referring again to FIGS. 25-26, the example securing plate 284 defines a securing plate outer edge 292, a securing plate front side inner surface 294, a securing plate outer surface 296, and a set of securing bores 298. The securing bores 298 are threaded. The securing plate inner surface 294 defines a securing plate configuration as shown in FIG. 24. FIG. 24 also shows that the example securing bores 298 are arranged in a securing bore pattern. The example securing plate configuration is generally circular but extends in a securing plate arc of approximately 190-210 degrees. The securing bore pattern is centered on an axis of the securing plate configuration and extends in an arc of approximately 170-190 degrees with the five securing bores 298 arranged at substantially evenly spaced intervals around the bore pattern arc.

The example securing members 300 defines a securing member shaft 302, and a securing member head 304, as shown in FIG. 23. The securing member head portions 304 of the securing members 300 are sized and dimensioned to be received at least partly by the securing bores 298 of the securing plate 284 and to engage the spacing members 236 to prevent the securing members 236 from passing entirely through the securing bores 298. The securing member shaft 302 is threaded to engage the threaded securing bores 298. The length of the securing member shaft 302 is sized to engage and secure the brace plate 230 to the securing plate 284.

Each of the plurality of spacing members 236 defines a spacing member shaft 370, a spacing member head 372, and a spacing member anchor portion 374, as shown in FIG. 23. In the example spacing members 236, the spacing member head 372 is arranged on an opposite end of the spacing member shaft 370 from the spacing member anchor portion 374. The head portions 372 of the example first spacing members 236 are sized and dimensioned to be received at least partly within brace bore outer portion 350 and to engage the brace bore engaging surface to prevent the first spacing members 236 from passing entirely through the brace bores 348.

The spacing member head portions 372 define an inner engaging surface 306 that is sized and dimensioned to receive at least a portion of an anchor portion of the securing members 300. The inner engaging surface 306 is threaded. The securing member shaft 302 of the securing members 300 is threaded to engage the threaded inner engaging surface 306 of the spacing members 236. The spacing members 300 are axially rotated such that the securing member shafts 302 are threadingly engaged to the spacing members 236 to prevent the securing members 300 from passing entirely through the securing plate 284. The length of the securing member shaft 302 determines a distance between the securing plate 284 and the brace plate 230.

The example brace rod 240 and brace nut 244 are or may be the same as the example brace rod 240 and brace nut 244 described above and will not be described herein again in detail.

To assemble the second example press tool 220, the anchor plate 230 and brace plate 232 are arranged such that the anchor bores 326 are aligned with the brace bores 348. The first spacing members 236 are then inserted through the brace bores 348 and axially rotated such that the spacing member anchor portions 374 threadingly engage the anchor bores 328. The brace plate 232 is then displaced relative to the anchor plate 230 such that the spacing member heads 372 engage the brace bore engaging surfaces 354. At that point, the second example press tool 220 is in its desired configuration. The securing plate 284 may be placed on top of the first spacing members 236 and secured by inserting the securing member shaft 302 through the securing bore 326 and threadingly engaging the securing member shaft 302 with the inner engaging surface 306 of the spacing members 236. The securing plate 300 and the anchor plate 232 may be easily removed and replaced if necessary.

The second example press tool system 220 is otherwise used in a manner similar to that of the first example bushing assembly insertion system 20 described above.

What is claimed is:

1. A press tool for disconnecting a torque rod assembly from a structural support comprising:
an anchor plate;
a brace plate;
a drive rod supported by the brace plate;
a plurality of spacing members arranged between the anchor plate and the brace plate such that the press tool defines a tool opening; and
at least one retaining member configured to be detachably attached to the brace plate; wherein
when the plurality of spacing members is arranged between the anchor plate and the brace plate, the at least one retaining member is detachably attached to the brace plate to secure at least one of the plurality of spacing members relative to the brace plate to fix a distance between the anchor plate and the brace plate;
the press tool is configured such that at least a portion of the torque rod assembly and the structural support may be passed through the tool opening such that the anchor plate engages at least a portion of the structural support;
the drive rod is axially rotated relative to the brace plate such that
the drive rod engages at least a portion of the torque rod assembly,
the anchor plate is fixed relative to the structural support, and
the drive rod displaces the torque rod assembly relative to the structural support.

2. The press tool of claim 1, wherein the brace plate defines a set of brace bores.

3. The press tool of claim 2, wherein the brace bores are arranged in a brace bore pattern configured to arrange the spacing members relative to the drive rod such that the distance between the anchor plate and the brace plate is fixed when the drive rod displaces the torque rod assembly relative to the structural support.

4. The press tool of claim 3, wherein the anchor plate comprises a set of anchor bores.

5. The press tool of claim 4, wherein the set of anchor bores is arranged in an anchor bore pattern configured to arrange the spacing members relative to the drive rod such that the distance between the anchor plate and the brace plate is fixed when the drive rod displaces the torque rod assembly relative to the structural support.

6. The press tool of claim 5, wherein the brace bore pattern substantially matches the anchor bore pattern defined by the anchor plate.

7. The press tool of claim 5, wherein the anchor bores are aligned with the brace bores.

8. The press tool of claim 7, wherein the plurality of spacing members are inserted through the brace bores and axially rotated such that the spacing members engage the anchor bores.

9. The press tool of claim 8, wherein the plurality of spacing members defines a distance between the anchor plate and the brace plate.

10. The press tool of claim 9, wherein the distance between the anchor plate and the brace plate defines a tool opening configured to receive at least a portion of the torque rod assembly and at least a portion of the structural support.

11. The press tool of claim 1, wherein the at least one retaining member is a retaining clip.

12. The press tool of claim 1, wherein the at least one retaining member is a securing plate.

13. The press tool of claim 12, further comprising at least one securing member arranged to detachably attach the at least one securing plate to the anchor plate.

14. The press tool of claim 1, further comprising at least one securing member arranged to detachably attach the at least one retaining member to the anchor plate.

15. The press tool of claim 4, wherein the set of anchor bores comprises an anchor bore outer portion, an anchor bore inner portion, and an anchor bore engaging surface.

16. A method of disconnecting a torque rod assembly from a structural support comprising the steps of:
providing an anchor plate;
providing a brace plate;
supporting a drive rod on the brace plate; and
arranging a plurality of spacing members between the anchor plate and the brace plate to define a tool opening;
detachably attaching at least one retaining member to the brace plate to secure at least one of the plurality of spacing members relative to the brace plate to fix a distance between the anchor plate and the brace plate;
passing at least a portion of the torque rod assembly and the structural support through the tool opening such that the anchor plate engages at least a portion of the structural support; and
axially rotating the drive rod relative to the brace plate such that
the drive rod engages at least a portion of the torque rod assembly,
the plurality of spacing members fix a distance between the anchor plate and the brace plate,
the anchor plate is fixed relative to the structural support, and
the drive rod displaces the torque rod assembly relative to the structural support.

17. The method of claim 16, wherein the torque rod assembly comprises a torque rod end, a torque rod pin assembly and a bushing.

18. The method of claim 17, further comprising connecting the torque rod assembly to the structural support by arranging the bushing within a torque rod end bore.

19. The method of claim 18, further comprising axially rotating the drive rod such that the bushing displaces out of the torque rod end bore and the bushing is fully disengaged from the torque rod end.

20. The method of claim 16, wherein the at least one retaining member is a retaining clip.

21. The method of claim 16, wherein the at least one retaining member is a securing plate.

22. The method of claim 21, further comprising the step of arranging at least one securing member to detachably attach the at least one securing plate to the anchor plate.

23. The method of claim 16, further comprising the step of arranging at least one securing member to detachably attach the at least one retaining member to the anchor plate.
